(19) United States
(12) Patent Application Publication
(10) Pub. No.: US 2014/0250716 A1
(43) Pub. Date: Sep. 11, 2014

(54) DRYER APPLIANCE AND A METHOD FOR OPERATING THE SAME

(71) Applicant: GENERAL ELECTRIC COMPANY, Schenectady, NY (US)

(72) Inventors: Ionelia Silvia Prajescu, Louisville, KY (US); Richard Dustin Henderson, Louisville, KY (US)

(73) Assignee: GENERAL ELECTRIC COMPANY, Schenectady, NY (US)

(21) Appl. No.: 13/787,183

(22) Filed: Mar. 6, 2013

(51) Int. Cl. F26B 21/10

(52) U.S. Cl. CPC F26B 21/10
USPC 34/443; 34/282; 34/543

(57) ABSTRACT

A dryer appliance and a method for operating the same are provided. The method includes establishing a first temperature set point and a second temperature set point for the dryer appliance. The method also includes determining an operating condition of the dryer appliance and selecting an operating temperature of the dryer appliance from the first and second temperature set points.

### FIELD OF THE INVENTION

The present subject matter relates generally to dryer appliances.

### BACKGROUND OF THE INVENTION

Certain dryer appliances include a cabinet with a drum rotatably mounted therein. A heating assembly, such as an electric resistance heating element or a gas burner, can supply heated air to a chamber of the drum. For example, certain dryer appliances include a duct mounted to a back wall of the drum. The duct can direct heated air from the heating assembly into the chamber of the drum during operation of the dryer appliance. The duct generally includes an inlet that receives heated air from the heating assembly and a plurality of outlets for directing such heated air into the chamber of the drum. In particular, the back wall of the drum can define an opening, and outlets of the duct can be positioned such that heated air from the duct enters the chamber through the back wall's opening. Such heated air can assist with drying articles located within the drum's chamber.

Heated air exiting the duct's outlets is preferably maintained below a certain threshold temperature, e.g., to avoid damaging articles that are drying within the chamber of the drum and other overheating problems. Certain dryer appliances are equipped with temperature sensors for monitoring the temperature of heated air entering the drum's chamber. If the temperature sensor detects overly hot air entering the drum's chamber, the heating assembly can be deactivated or cycled. Such cycling can negatively affect performance of the dryer appliance by increasing drying times.

Dryer appliances generally have a single threshold temperature for regulating air temperature at the duct's outlets. However, dryer appliances can experience a range of flow restrictions depending upon the installation of the dryer appliance. For example, long vent conduits and lent buildup therein can increase the dryer appliance's flow restriction. Operating the dryer appliance at a single threshold temperature for both restricted and unrestricted conditions can have several drawbacks. In particular, the threshold temperature is preferably selected to prevent the dryer appliance from overheating in restricted conditions, but such a threshold temperature can result in the dryer appliance's heating assembly unnecessarily cycling in unrestricted conditions. Such cycling can increase drying times of the dryer appliance and negatively affect dryer appliance performance.

Accordingly a dryer appliance with features for improving performance of the dryer appliance would be useful. In particular, a dryer appliance with features for limiting cycling of a heating assembly of the dryer appliance in an unrestricted conditions would be useful.

### BRIEF DESCRIPTION OF THE INVENTION

The present subject matter provides a dryer appliance and a method for operating the same. The method includes establishing a first temperature set point and a second temperature set point for the dryer appliance. The method also includes determining an operating condition of the dryer appliance and selecting an operating temperature of the dryer appliance from the first and second temperature set points. Additional aspects and advantages of the invention will be set forth in part in the following description, or may be apparent from the description, or may be learned through practice of the invention.

In a first exemplary embodiment, a method for operating a dryer appliance is provided. The method includes establishing a first temperature set point for the dryer appliance and a second temperature set point for the dryer appliance. The first and second temperature set points are different. The method also includes activating the dryer appliance and determining an operating condition of the dryer appliance. The operating condition is either a restricted condition or an unrestricted condition. The method further include selecting an operating temperature of the dryer appliance from the first and second temperature set points based at least in part on the operating condition of the step of determining.

In a second exemplary embodiment, a dryer appliance is provided. The dryer appliance includes a cabinet and a drum rotatably mounted within the cabinet. The drum defines a chamber for receipt of articles for drying. The dryer appliance also includes a heating assembly for generating heated air. A duct extends between and fluidly connects the heating assembly and the drum. A temperature sensor is positioned with the duct. The temperature sensor is configured for measuring a temperature of heated air within the duct. A controller is in operative communication with the heating assembly and the temperature sensor. The controller is configured for receiving a first temperature set point for the temperature sensor and a second temperature set point for the temperature sensor, activating the heating assembly, and determining an operating condition of the dryer appliance. The operating condition is either a restricted condition or an unrestricted condition. The controller is also configured for selecting an operating temperature of the dryer appliance from the first and second temperature set points based at least in part on the operating condition of the dryer appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a dryer appliance according to an exemplary embodiment of the present subject matter.

FIG. 2 provides a perspective view of the dryer appliance of FIG. 1 with portions of a cabinet of the dryer appliance removed to reveal certain components of the dryer appliance.

FIG. 3 provides a schematic view of certain components of the dryer appliance of FIG. 1.

FIG. 4 illustrates a method for operating a dryer appliance according to an exemplary embodiment of the present subject matter.

FIGS. 5 and 6 illustrate graphs of time versus exemplary temperature measurements of a temperature sensor and time versus exemplary temperatures of air exiting various outlets of a duct.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

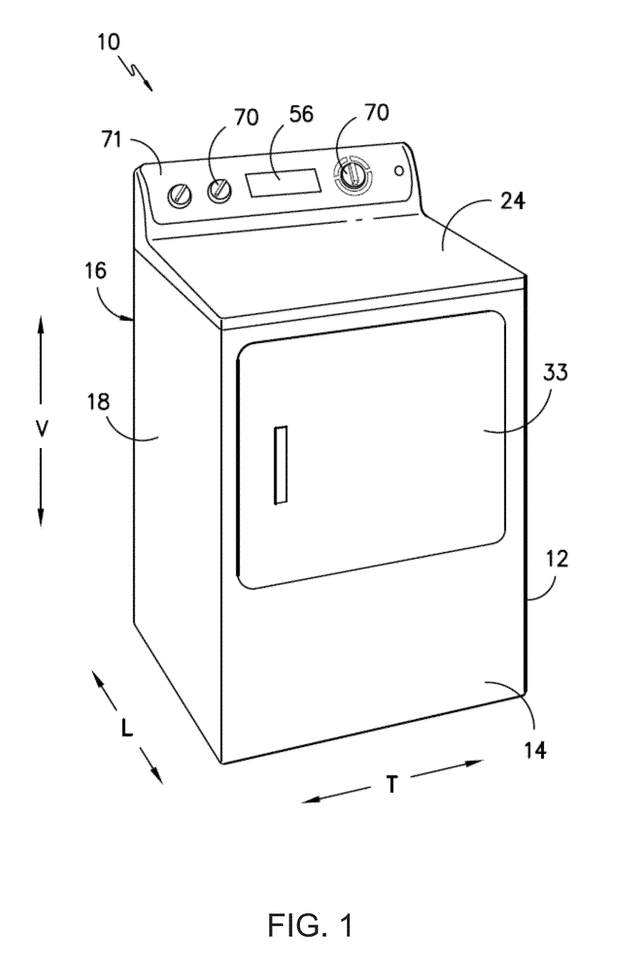

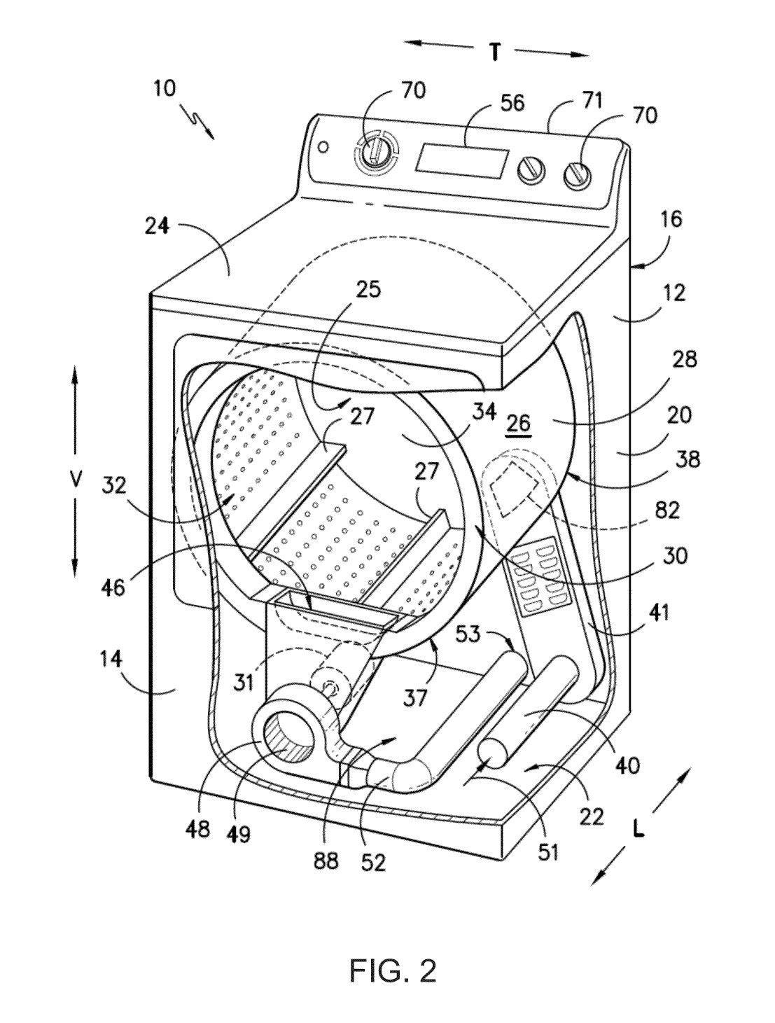

FIG. 1 illustrates a dryer appliance 10 according to an exemplary embodiment of the present subject matter. FIG. 2 provides another perspective view of dryer appliance 10 with a portion of a cabinet or housing 12 of dryer appliance 10 removed in order to show certain components of dryer appliance 10. While described in the context of a specific embodiment of dryer appliance 10, using the teachings disclosed herein it will be understood that dryer appliance 10 is provided by way of example only. Other dryer appliances having different appearances and different features may also be utilized with the present subject matter as well. Dryer appliance 10 defines a vertical direction V, a lateral direction L, and a transverse direction T. The vertical direction V, lateral direction L, and transverse direction T are mutually perpendicular and form and orthogonal direction system.

Cabinet 12 includes a front panel 14, a rear panel 16, a pair of side panels 18 and 20 spaced apart from each other by front and rear panels 14 and 16, a bottom panel 22, and a top cover 24. Within cabinet 12 is a drum or container 26 mounted for rotation about a substantially horizontal axis, e.g., that is parallel or substantially parallel to the lateral direction L. Drum 26 defines a chamber 25 for receipt of articles, e.g., clothing, linen, etc., for drying. Drum 26 extends between a front portion 37 and a back portion 38, e.g., along the lateral direction L.

A motor 31 is configured for rotating drum 26 about the horizontal axis, e.g., via a pulley and a belt (not shown). Drum 26 is generally cylindrical in shape, having an outer cylindrical wall or cylinder 28 and a front flange or wall 30 that defines an entry 32 of drum 26, e.g., at front portion 37 of drum 26, for loading and unloading of articles into and out of chamber 25 of drum 26. A plurality of tumbling ribs 27 are provided within chamber 25 of drum 26 to lift articles therein and then allow such articles to tumble back to a bottom of drum 26 as drum 26 rotates. Drum 26 also includes a back or rear wall 34, e.g., at back portion 38 of drum 26. Cylinder 28 is rotatable on rear wall 34 as will be understood by those skilled in the art. A duct 41 is mounted to rear wall 34 and receives heated air that has been heated by a heating assembly or system 40.

Motor 31 is also in mechanical communication with an air handler 48 such that motor 31 rotates a fan 49, e.g., a centrifugal fan, of air handler 48. Air handler 48 is configured for drawing air through chamber 25 of drum 26, e.g., in order to dry articles located therein as discussed in greater detail below. In alternative exemplary embodiments, dryer appliance 10 may include an additional motor (not shown) for rotating fan 49 of air handler 48 independently of drum 26.

Drum 26 is configured to receive heated air that has been heated by a heating assembly 40, e.g., in order to dry damp articles disposed within chamber 25 of drum 26. Heating assembly 40 includes a heating element (not shown), such as a gas burner or an electrical resistance heating element, for heating air. As discussed above, during operation of dryer appliance 10, motor 31 rotates drum 26 and fan 49 of air handler 48 such that air handler 48 draws air through chamber 25 of drum 26 when motor 31 rotates fan 49. In particular, ambient air enters heating assembly 40 via an entrance 51 due to air handler 48 urging such ambient air into entrance 51. Such ambient air is heated within heating assembly 40 and exits heating assembly 40 as heated air. Air handler 48 draws such heated air through duct 41 to drum 26. The heated air enters drum 26 through an outlet 82 of duct 41 positioned at rear wall 34 of drum 26.

Within chamber 25, the heated air can accumulate moisture, e.g., from damp articles disposed within chamber 25. In turn, air handler 48 draws moisture statured air through a screen filter (not shown) which traps lint particles. Such moisture statured air then enters an exit conduit 46 and is passed through air handler 48 to an exhaust conduit 52. From exhaust conduit 52, such moisture statured air passes out of dryer appliance 10 through a vent 53 defined by cabinet 12. After the clothing articles have been dried, they are removed from the drum 26 via entry 32. A door 33 provides for closing or accessing drum 26 through entry 32.

A cycle selector knob 70 is mounted on a cabinet backsplash 71 and is in communication with a processing device or controller 56. Signals generated in controller 56 operate motor 31 and heating assembly 40 in response to the position of selector knobs 70. Alternatively, a touch screen type interface, knobs, sliders, buttons, speech recognition, etc., mounted to cabinet backsplash 71 can permit a user to input control commands for dryer appliance 10 and/or controller 56.

Controller 56 may include memory and one or more processing devices such as microprocessors, CPUs or the like, such as general or special purpose microprocessors operable to execute programming instructions or micro-control code associated with operation of dryer appliance 10. The memory can represent random access memory such as DRAM, or read only memory such as ROM or FLASH. The processor executes programming instructions stored in the memory. The memory may be a separate component from the processor or may be included onboard within the processor. Alternatively, controller 56 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

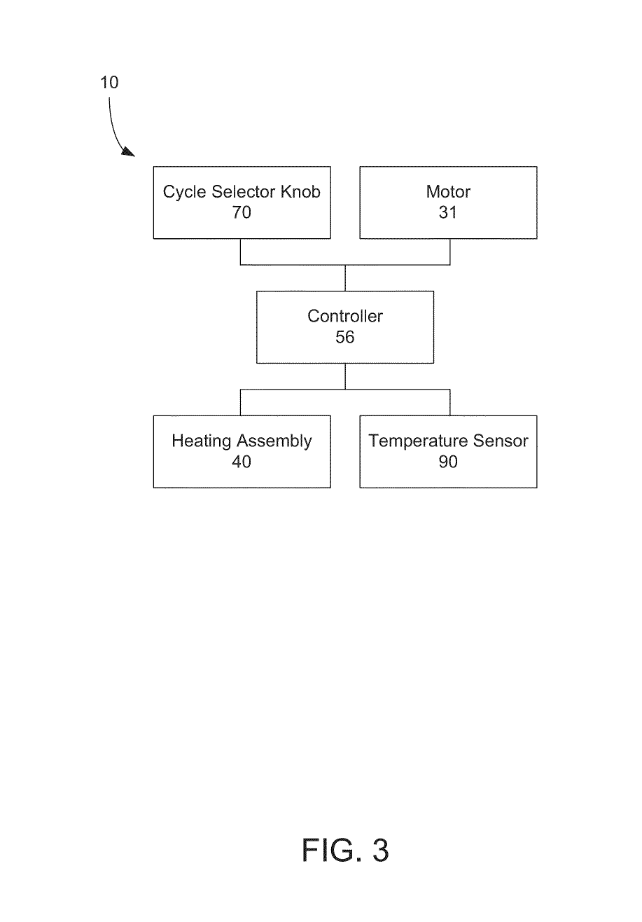

FIG. 3 provides a schematic view of certain components of dryer appliance 10. As may be seen in FIG. 3, controller 56 is in operative communication with various components of dryer appliance 10. In particular, controller 56 is in operative communication with motor 31 and heating assembly 40. Thus, upon receiving an activation signal from cycle selector knob 70, controller 56 can activate motor 31 to rotate drum 26 and fan 49 of air handler 48. Controller 56 can also activate heating assembly 40 in order to generate heated air for drum 26, e.g., in the manner described above.

Controller 56 is also in communication with a thermal or temperature sensor 90, e.g., a thermocouple or thermistor. Temperature sensor 90 is configured for measuring a temperature of heated air within duct 41. Temperature sensor 90 can be positioned at any suitable location within dryer appliance 10. For example, temperature sensor 90 may be positioned within or on duct 41. Controller 56 can receive a signal from temperature sensor 90 that corresponds to a temperature measurement of heated air within duct 41, e.g., a temperature measurement of heated air exiting duct 41 at outlet 82.

Dryer appliance 10 also includes features for improving performance of dryer appliance 10. In particular, dryer appliance 10 includes features for limiting cycling of heating assembly 40 of dryer appliance 10. Such features are discussed in greater detail below.

As will be understood by those skilled in the art, dryer appliance 10 can be installed at various locations. The particular arrangement and setup of dryer appliance 10 at such locations can affect performance of dryer appliance 10. For example, a conduit (not shown) can be attached to vent 53 (FIG. 2) of dryer appliance 10 and receive moisture saturated air therefrom. The conduit can direct such moisture statured air out of a building housing dryer appliance 10. Thus, the conduit assists dryer appliance 10 with drying articles. However, the length of conduit can affect performance of dryer appliance 10. For example, if the conduit is relatively long, it can be more difficult for air handler 48 to urge air out of vent 53 and through the conduit. Conversely, it can be relatively easier for air handler 48 to urge air out of vent 53 and through the conduit if the conduit is relatively short. The length of the conduit can vary depending upon the location of dryer appliance 10 within building. Thus, if dryer appliance 10 is located near an exterior wall, the conduit can be relatively short. Converse, the conduit can be relatively long if dryer appliance 10 is distant from the exterior wall.

In a similar manner, lint and other debris within the conduit can also affect performance of dryer appliance 10. For example, if the conduit has a relatively large volume of debris therein, it can be more difficult for air handler 48 to urge air out of vent 53 and through the conduit. Conversely, it can be relatively easier for air handler 48 to urge air out of vent 53 and through the conduit if the conduit has a relatively small volume of debris therein.

Accordingly, the length of the conduit, the volume of debris within the conduit, and other factors can affect performance of dryer appliance 10. When such factors negatively affect performance of dryer appliance 10 to a significant degree, dryer appliance 10 is operating in a restricted condition. Conversely, dryer appliance 10 is operating in an unrestricted condition when such factors do not affect performance of dryer appliance 10 to a significant degree. As an example, when the conduit is relatively long and/or the conduit contains a relatively large volume of debris, dryer appliance 10 is operating in the restricted condition. Conversely, dryer appliance 10 is operating in the unrestricted condition when the conduit is relatively short and/or the conduit contains a relatively small volume of debris.

To assist with improving performance of dryer appliance 10, controller 56 can determine an operating condition of dryer appliance 10. In particular, controller 56 can determine whether the operating condition of dryer appliance 10 is the restricted condition or the unrestricted condition. For example, controller 56 can calculate a temperature change for heated air within duct 41 between a first time and a second time. Controller 56 can determine that dryer appliance 10 is operating in the restricted condition or the unrestricted condition based at least in part on the temperature change for the heated air between the first and second times. In particular, controller 56 can determine that dryer appliance 10 is operating in the restricted condition if the temperature change for the heated air is greater than a threshold value between the first and second times. Conversely, controller 56 can determine that dryer appliance 10 is operating in the unrestricted condition if the temperature change for the heated air is less than the threshold value between the first and second times.

Controller 56 can also select an operating temperature of dryer appliance 10 based at least in part on the operating condition of dryer appliance 10. For example, controller 56 can select the operating temperature of dryer appliance 10 from a first temperature set point and a second temperature set point. The first and second temperature set points are different than each other. The first temperature set point can correspond to a maximum operating temperature of dryer appliance 10 in the restricted condition. Conversely, the second temperature set point can correspond to the maximum operating temperature of dryer appliance 10 in the unrestricted condition. Thus, controller 56 selects the first temperature set point if the operating condition of dryer appliance 10 is the restricted condition, and controller 56 selects the second temperature set point if the operating condition of dryer appliance 10 is the unrestricted condition. By selecting the maximum operating temperature of dryer appliance 10 based upon the operating condition of dryer appliance 10, performance of dryer appliance 10 can be improved.

As will be understood by those skilled in the art, the temperature of the heated air flowing out of duct 41 is preferably maintained below a certain threshold temperature, e.g., about four hundred degrees Fahrenheit, in order to avoid damaging articles drying within chamber 25 and other problems. When the temperature of the heated air flowing out of duct 41 exceeds the threshold temperature, controller 56 can cycle the heating assembly 40 by reducing a power output of heating assembly 40 or deactivating heating assembly 40 in order to reduce the temperature of the heated air flowing out of duct 41.

In the unrestricted condition, a volume of heated air flowing out of duct 41 can be relatively high, and a temperature of the heated air can be relatively low. Conversely, in the restricted condition, the volume of heated air flowing out of duct 41 can be relatively low, and the temperature of the heated air can be relatively high. By selecting the maximum operating temperature of dryer appliance 10 based upon the operating condition of dryer appliance 10, unnecessary cycling of dryer appliance 10 can be avoided or limited.

In particular, the first temperature set point can be less than the second temperature set point. For example, the first temperature set point may be about twenty degrees Fahrenheit less than the second temperature set point. Thus, by selecting the first temperature set point when the operating condition of dryer appliance 10 is the restricted condition, dryer appliance 10 can operate closer to the threshold temperature because the volume of heated air flowing out of duct 41 is relatively high and the temperature of such heated air is relatively low compared to the restricted condition. Conversely, by selecting the second temperature set point when the operating condition of dryer appliance 10 is the unrestricted condition, dryer appliance 10 can operate further from the threshold temperature and thereby avoid exceeding the threshold temperature because the temperature of heated air exiting duct 41 is relatively high compared to the unrestricted condition.

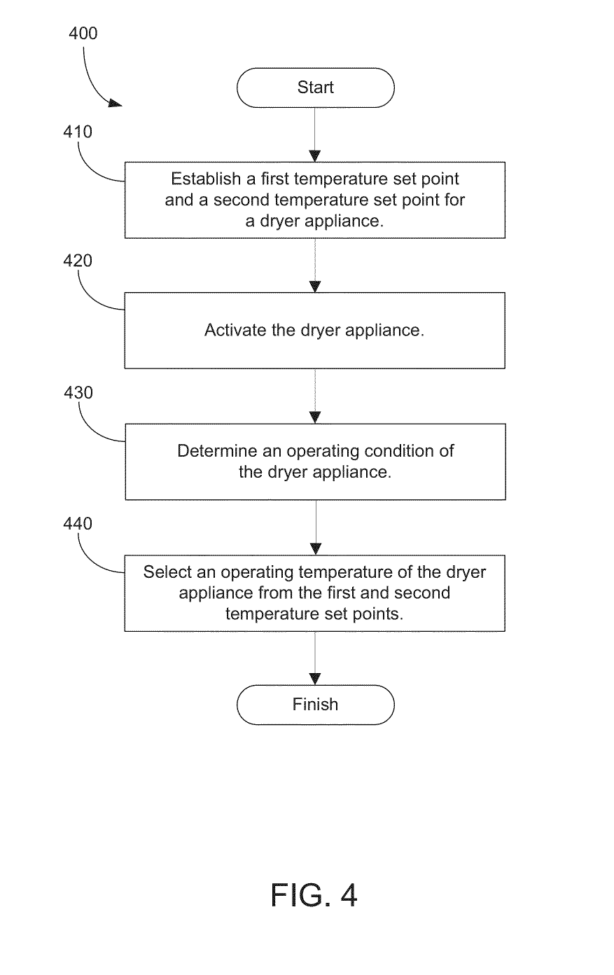

FIG. 4 illustrates a method 400 for operating a dryer appliance according to an exemplary embodiment of the present subject matter. Method 400 can be used to operate any suitable dryer appliance. For example, method 400 may be used to operate dryer appliance 10 (FIG. 1). In particular, controller 56 (FIG. 1) may be programmed to implement method 400.

At step 410, controller 56 establishes the first temperature set point for dryer appliance 10 and the second temperature set point for dryer appliance 10. The first and second temperature set points can be established in any suitable manner at step 410. For example, the first and second temperature set points may be selected by a user of dryer appliance 10 or the first and second temperature set points may be selected by a manufacturer of dryer appliance 10, e.g., during assembly or manufacture of dryer appliance 10.

At step 420, controller 56 activates dryer appliance 10. As an example, controller 56 can activate motor 31 and/or heating assembly 40 of dryer appliance 10 at step 420. By activating dryer appliance 10 at step 420, articles within chamber 25 of drum 26 can be dried.

At step 430, controller 56 determines the operating condition of dryer appliance 10. In particular, controller 56 determines whether dryer appliance 10 is in the restricted condition or the unrestricted condition. Controller 56 can determine the operating condition of dryer appliance 10 at step 430 utilizing any suitable method. For example, a user of dryer appliance 10 may signal controller 56 whether dryer appliance 10 is in the restricted or unrestricted condition. As another example, controller 56 may calculate a time interval between when a temperature of heated air entering drum 26 of dryer appliance 10 increases from a first reference temperature to a second reference temperature and utilize the time interval to determine the operating condition of dryer appliance 10. As a further example, controller 56 may measure a temperature of heated air entering drum 26 at a first time with temperature sensor 90, and controller 56 may measure the temperature of heated air entering drum 26 at a second, e.g., later, time with temperature sensor 90. Controller 56 may then calculate the temperature change for the heated air between the first and second times, e.g., by taking the difference between the two values. Controller 56 can select the restricted condition or the unrestricted condition based at least in part on the temperature change for the heated air between the first and second times.

At step 440, controller 56 selects the operating temperature of dryer appliance 10 from the first and second temperature set points based at least in part on the operating condition of step 430. Controller 56 may selects the first temperature set point if the operating condition of dryer appliance 10 is the restricted condition at step 430, or controller 56 may select the second temperature set point if the operating condition of dryer appliance 10 is the unrestricted condition at step 430.

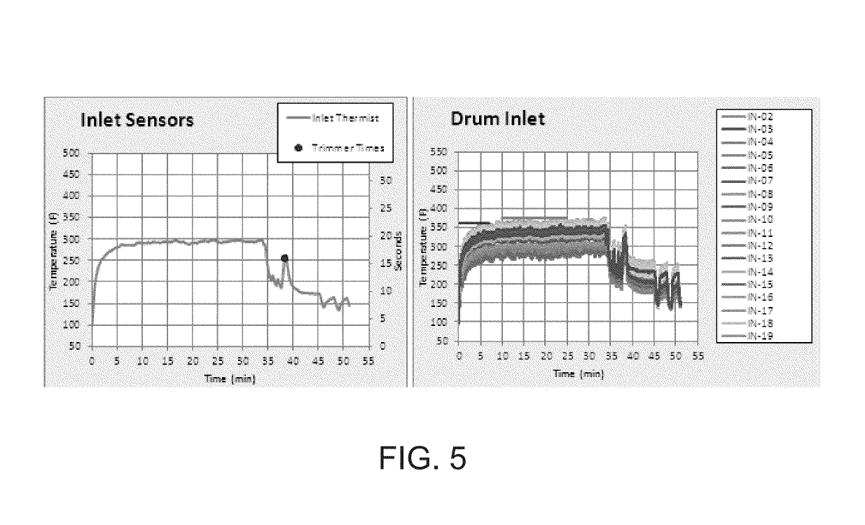

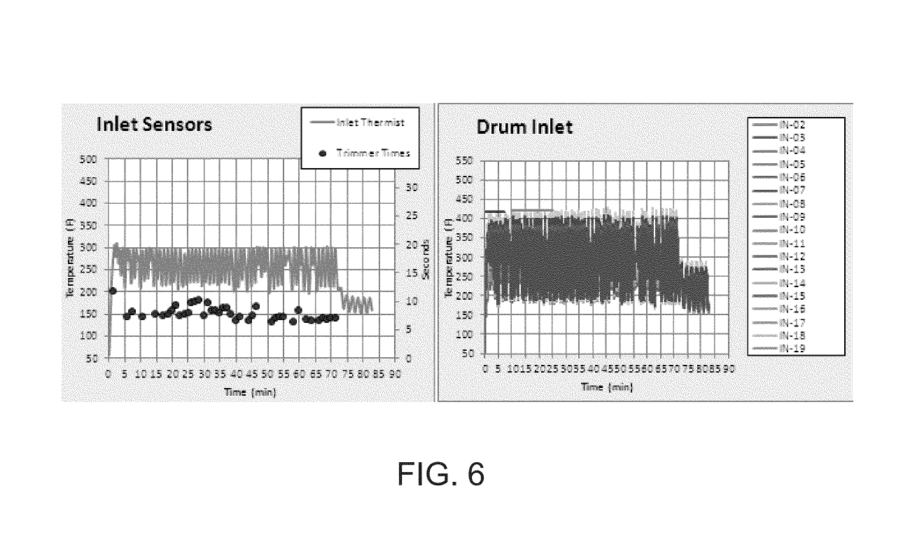

FIGS. 5 and 6 illustrate graphs of time versus exemplary temperature measurements of temperature sensor 90 and time versus exemplary temperatures of air exiting various outlets of duct 41. In FIG. 5, dryer appliance 10 is operating in the unrestricted condition, e.g., about a two and six hundred and twenty-five thousandths of an inch restriction, and temperature sensor 90 is set to the first temperature set point. Conversely, dryer appliance 10 is operating in the restricted condition, e.g., about a one and one half inch restriction, and temperature sensor 90 is set to the second temperature set point in FIG. 6.

As may be seen in FIG. 5, heating assembly 40 of dryer appliance 10 does not cycle during the first thirty-five minutes of the drying cycle in the unrestricted condition with temperature sensor 90 set to the first temperature set point. Between about five minutes and about thirty-five minutes, temperature sensor 90 reads about three hundred degrees Fahrenheit. By not cycling during such time period, performance of dryer appliance 10 is improved and drying time of dryer appliance 10 is reduced.

As may be seen in FIG. 6, heating assembly 40 of dryer appliance 10 cycles consistently for more than seventy minutes of the drying cycle in the restricted condition with temperature sensor 90 set to the second temperature set point. During the seventy minutes, temperature sensor 90 reads between about two hundred and about three hundred degrees Fahrenheit. By cycling during such time period, drying time of dryer appliance 10 is increased relative to the unrestricted condition of FIG. 5.

Measurements of temperature sensor 90 in the unrestricted condition increase steadily and relatively slowly compared to measurements of temperature sensor 90 in the restricted condition. Thus, the temperature of heated air entering drum 26 in the restricted condition increases rapidly compared to the temperature of heated air entering drum 26 in the unrestricted condition as shown in FIGS. 5 and 6. To avoid overheating in the restricted condition due to the rapidly increasing heated air temperature, controller 56 selects the second temperature set point as the operating temperature of dryer appliance 10 in the restricted condition, e.g., because the second temperature set point is less than the first temperature set point and measurements of temperature sensor 90 can lag behind the actual heated air temperature. Conversely, to avoid unnecessary cycling of heating assembly 40, controller 56 selects the first temperature set point as the operating temperature of dryer appliance 10 in the unrestricted condition, e.g., because the first temperature set point is greater than the second temperature set point and measurements of temperature sensor 90 are more accurate in the unrestricted condition.

Controller 56 can determine that dryer appliance 10 is operating in the restricted condition if the temperature change for the heated air during a particular time period is greater than a threshold value as shown in FIG. 6. Conversely, controller 56 can determine that dryer appliance 10 is operating in the unrestricted condition if the temperature change for the heated air during the particular time period is less than the threshold value as shown in FIG. 5. Thus, when measurements of temperature sensor 90 increase relatively rapidly during the particular time period, controller 56 can determine that dryer appliance 10 is operating in the restricted condition. Conversely, controller 56 can determine that dryer appliance 10 is operating in the unrestricted condition when measurements of temperature sensor 90 increase relatively slowly during the particular time period. The particular time period can be taken at any suitable time during the drying cycle. For example, the particular time period may be taken at a start of the drying cycle or whenever measurements of temperature sensor 90 pass through a certain range of temperatures, e.g., every time heating assembly 40 cycles.

It should be understood that in certain exemplary embodiments, the first and second temperature set points can each comprise a high set point and a low set point. Heating assembly 40 can decrease power output when the temperature of heated air entering drum 26 exceeds the low set point, and heating assembly 40 can deactivate when the temperature of heated air entering drum 26 exceeds the high set point.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a dryer appliance, comprising:
establishing a first temperature set point for the dryer appliance and a second temperature set point for the dryer appliance, the first and second temperature set points being different;
activating the dryer appliance;
determining an operating condition of the dryer appliance, the operating condition being either a restricted condition or an unrestricted condition;
selecting an operating temperature of the dryer appliance from the first and second temperature set points based at least in part on the operating condition of said step of determining.

2. The method of claim 1, wherein said step of determining comprises calculating a time interval between when a temperature of heated air entering a drum of the dryer appliance increases from a first reference temperature to a second reference temperature.

3. The method of claim 1, wherein said step of selecting comprises selecting the first temperature set point if the operating condition of the dryer appliance is the restricted condition at said step of determining or selecting the second temperature set point if the operating condition of the dryer appliance is the unrestricted condition at said step of determining.

4. The method of claim 1, wherein the first temperature set point is less than the second temperature set point.

5. The method of claim 4, wherein the first temperature set point is about twenty degrees Fahrenheit less than the second temperature set point.

6. The method of claim 1, wherein said step of determining comprises:
measuring a temperature of heated air entering a drum of the dryer appliance at a first time;
measuring the temperature of heated air entering the drum of the dryer appliance at a second time; and
calculating a temperature change for the heated air between the first and second times.

7. The method of claim 1, wherein said step of determining further comprises selecting the restricted condition or the unrestricted condition based at least in part on the temperature change for the heated air.

8. The method of claim 7, wherein the restricted condition corresponds to when the temperature change for the heated air is greater than a threshold value and the unrestricted condition corresponds to when the temperature change for the heated air is less than the threshold value.

9. The method of claim 1, wherein the first temperature set point corresponds to a maximum operating temperature of the dryer appliance in the restricted condition and the second temperature set point corresponds to the maximum operating temperature of the dryer appliance in the unrestricted condition.

10. The method of claim 1, wherein the first and second temperature set points each comprise a high set point and a low set point, a heating assembly of the dryer appliance decreasing power output when a temperature of heated air entering a drum of the dryer appliance exceeds the low set point and the heating assembly deactivating when the temperature of heated air entering the drum of the dryer appliance exceeds the high set point.

11. A dryer appliance, comprising:
a cabinet;
a drum rotatably mounted within said cabinet, said drum defining a chamber for receipt of articles for drying;
a heating assembly for generating heated air;
a duct that extend between and fluidly connects said heating assembly and said drum;
a temperature sensor positioned within said duct, said temperature sensor configured for measuring a temperature of heated air within said duct; and
a controller in operative communication with said heating assembly and said temperature sensor, said controller configured for
receiving a first temperature set point for said temperature sensor and a second temperature set point for said temperature sensor;
activating said heating assembly;
determining an operating condition of the dryer appliance, the operating condition being either a restricted condition or an unrestricted condition; and
selecting an operating temperature of the dryer appliance from the first and second temperature set points based at least in part on the operating condition of the dryer appliance.

12. The dryer appliance of claim 11, wherein said step of determining comprises:
measuring the temperature of heated air within said duct with said temperature sensor at a first time;
measuring the temperature of heated air within said duct with said temperature sensor at a second time; and
calculating a temperature change for the heated air between the first and second times.

13. The dryer appliance of claim 12, wherein said step of determining further comprises selecting the restricted condition or the unrestricted condition based at least in part on the temperature change for the heated air.

14. The dryer appliance of claim 13, wherein the restricted condition corresponds to when the temperature change for the heated air is greater than a threshold value and the unrestricted condition corresponds to when the temperature change for the heated air is less than the threshold value.

15. The dryer appliance of claim 11, wherein the first temperature set point corresponds to a maximum operating temperature of the dryer appliance in the restricted condition and the second temperature set point corresponds to the maximum operating temperature of the dryer appliance in the unrestricted condition.

16. The dryer appliance of claim 11, wherein said step of selecting comprises selecting the first temperature set point if the operating condition of the dryer appliance is the restricted condition at said step of determining or selecting the second temperature set point if the operating condition of the dryer appliance is the unrestricted condition at said step of determining.

17. The dryer appliance of claim 1, wherein the first temperature set point is less than the second temperature set point.

18. The dryer appliance of claim 17, wherein the first temperature set point is about twenty degrees Fahrenheit less than the second temperature set point.

19. The dryer appliance of claim 11, wherein the first and second temperature set points each comprise a high set point and a low set point, said controller operating said heating assembly at a decreased power setting when temperature measurements of said temperature sensor exceed the low set point and said controller deactivating said heating assembly when temperature measurements of said temperature sensor exceed the high set point.
